(19) United States
(12) Patent Application Publication
(10) Pub. No.: US 2026/0098944 A1
(43) Pub. Date: Apr. 9, 2026

(54) LiDAR DEVICE FOR A VEHICLE AND A VEHICLE INCLUDING THE SAME

(71) Applicants: HYUNDAI MOTOR COMPANY, Seoul (KR); KIA CORPORATION, Seoul (KR)

(72) Inventor: Seong Hwan Kim, Hwaseong-si (KR)

(73) Assignees: HYUNDAI MOTOR COMPANY, Seoul (KR); KIA CORPORATION, Seoul (KR)

(21) Appl. No.: 19/265,878

(22) Filed: Jul. 10, 2025

(30) Foreign Application Priority Data
Oct. 8, 2024 (KR) 10-2024-0136963

(51) Int. Cl. G01S 7/481; G01S 7/484

(52) U.S. Cl. CPC G01S 7/4817; G01S 7/484

(57) ABSTRACT

A light detection and ranging (LiDAR) device for a vehicle according to an embodiment of the present disclosure may include a heater supplying heat to a radiator, and a processor that controls the heater to control a radiation angle of a first direction of the radiator by transmitting a command for supplying power to the heater, in an FPA system including a pixel array of 1×N arrays for the first direction and a second direction, in which each pixel of the pixel array includes the radiator radiating light.

### CROSS-REFERENCE TO RELATED APPLICATIONS

The present application claims priority to Korean Patent Application No. 10-2024-0136963, filed on Oct. 8, 2024, the entire contents of which is incorporated herein for all purposes by this reference.

### TECHNICAL FIELD

The present disclosure relates to a LiDAR device for a vehicle and a vehicle including the LiDAR device.

### BACKGROUND

The statements in this section merely provide background information related to the present disclosure and may not constitute prior art.

Light detection and ranging (LiDAR) is a technology that enables obtaining distance information by measuring a time of a laser beam that is reflected from an object and returns using a pulse laser of high power. A LiDAR device may be used to measure a distance to an object by measuring a time which is taken for high-intensity laser light radiated from the device to return after reflected from the object. LiDAR was initially used as a compound word of light and radar and is currently widely used as an abbreviation of ‘light detection and ranging.’ It is also referred to as ‘laser radar’ because LiDAR uses laser instead of an electromagnetic wave compared to radio detection and ranging (RADAR) using radio wave. A LiDAR device is generally used to measure an atmospheric physical property (temperature, material distribution, concentration characteristic, and the like), a distance, a direction, a velocity, and the like more precisely by utilizing a characteristic of a laser (high density, a short period, pulse signal generation, and the like) that does not spread out over a long distance and has straightness.

In the LiDAR technology, there are two methods for measuring the distance. One is a pulsed time of flight (TOF) method in which a round-trip time of a pulse is measured and used for the distance. The other is a frequency modulated continuous wave (FMCW) method in which distance information is obtained based on a frequency difference of laser after changing the frequency. The pulsed TOF method is based on a principle of transmitting a laser light with a very short time pulse width to a target, measuring a time period which the laser light takes from the radiation to the returning after reflected from a target surface, and calculating a target distance with the time period and a velocity of light. The FMCW method uses the same principle as a FMCW radar. In the FMCW method, distance information of a target is included in a bit frequency, which may be obtained by applying a Fourier transform to a beat frequency signal which is obtained by using a reference signal and a reflected signal as input signals to a mixer.

Utilization of a photonic integrated circuit (PIC) using optical waveguides instead of metal lines in communication between various parts in an electronic system or apparatus is expanding, and this light communication technology is referred to as silicon photonics. Various research has been conducted for a silicon photonics-based LiDAR scanner, which has two types of utilizing an optical plane array (OPA) and utilizing a focal plane array (FPA). Compared to an existing system that steers a radiation direction of light using a mechanical rotation mechanism, a micro-electro-mechanical systems (MEMS) element, or the like, the silicon photonics-based scanner has an advantage of superior durability and reliability because a mechanical operation does not exist, and a manufacturing cost can be reduced because the silicon photonics-based scanner can be easily manufactured on a semiconductor chip using a semiconductor process. In particular, the FPA has a longer light radiation range, a wider field of view (FOV), easy control, and less light loss compared to the OPA. However, because the FPA requires many pixels for wide FOV and high resolution, a system utilizing the FPA becomes complex, power consumption and design difficulty are increased, and thus a solution for this is required.

The information included in this Background of the present disclosure section is only for enhancement of understanding of the general background of the present disclosure and may not be taken as an acknowledgement or any form of suggestion that this information forms the prior art already known to a person of ordinary skill in the art.

### SUMMARY

One embodiment of the present disclosure may reduce complexity, power consumption, chip area, and design difficulty by including a heater in a radiator to enable two-dimensional beam steering using a one-dimensional pixel array arrangement to implement a LiDAR device for a vehicle applying an FPA system having a wide field of view and high resolution, compared to an FPA system that applies a two-dimensional pixel array arrangement.

An embodiment of the present disclosure provides a LiDAR device for a vehicle which includes an FPA system of a one-dimensional pixel array, each pixel of the pixel array including a radiator to radiate light, and a processor which transmits a command for supplying power to a heater to supply heat to the radiator to control a radiation angle for a first direction of the radiator.

The technical objects to be achieved through the present disclosure are not limited to those described above, and other technical objects not described may be clearly understood from the description below by a person having an ordinary skill in the technical field to which the present disclosure belongs.

According to an embodiment of the present disclosure, a light detection and ranging (LiDAR) device for a vehicle may include at least one light source configured to generate light, at least one focal plane array (FPA) system including a 1×N (N being an integer greater than or equal to 2) pixel array with 1 representing a first direction and N representing a second direction, each pixel of the pixel array including a radiator radiating the light, a heater configured to supply heat to the radiator, and a processor configured to control the pixel and the heater, wherein the processor may transmit a command for supplying power to the heater to control a radiation angle for the first direction of the radiator.

According to at least one embodiment of the present disclosure, the command may include power information corresponding to the radiation angle for the first direction.

According to at least one embodiment of the present disclosure, the radiator may include a grating structure of a constant period.

According to at least one embodiment of the present disclosure, the radiation angle for the first direction may be controlled by an effective refractive index of the radiator being changed according to a temperature.

According to at least one embodiment of the present disclosure, the LiDAR device for the vehicle may further include at least one first switch configured to separate the light to provide to the pixel array.

According to at least one embodiment of the present disclosure, the LiDAR device for the vehicle may further include a directional coupler and/or an on-chip photodetector configured to monitor performance of the at least one first switch.

According to at least one embodiment of the present disclosure, the at least one light source may include a first light source of a first wavelength and a second light source of a second wavelength, and the LiDAR device may further include a first switch and a second switch configured to separate the light to provide to the pixel array, and a wavelength selection switch configured to switch at least one of the first wavelength or the second wavelength to the first switch, and switch at least one of the first wavelength or the second wavelength to the second switch.

According to at least one embodiment of the present disclosure, the at least one light source may include a plurality of light sources having different wavelengths, and the at least one FPA system may include a plurality of FPA systems having different grating periods of the radiator.

According to at least one embodiment of the present disclosure, the heater may include at least one of an n-i-n heater, a p-i-p heater, a p-i-n heater, a pn junction heater, o a thermal resistance heater.

According to at least one embodiment of the present disclosure, an intrinsic in the n-i-n heater, the p-i-p heater, or the p-i-n heater may include the radiator.

In a vehicle including a light detection and ranging (LiDAR) device according to an embodiment of the present disclosure, the LiDAR device includes at least one light source configured to generate light, at least one focal plane array (FPA) system including a 1×N (where N is an integer greater than or equal to 2) pixel array with 1 representing a first direction and N representing a second direction, in which each pixel of the pixel array includes a radiator radiating the light, a heater configured to supply heat to the radiator, and a processor configured to control the pixel and the heater, wherein the processor transmits a command for supplying power to the heater to control a radiation angle for the first direction of the radiator.

According to at least one embodiment of the present disclosure, the command may include power information corresponding to the radiation angle for the first direction.

According to at least one embodiment of the present disclosure, the radiator may include a grating structure of a constant period.

According to at least one embodiment of the present disclosure, the radiation angle for the first direction may be controlled by an effective refractive index of the radiator being changed according to a temperature.

According to at least one embodiment of the present disclosure, the LiDAR device may further include at least one first switch configured to separate the light to provide to the pixel array.

According to at least one embodiment of the present disclosure, the LiDAR device may further include a directional coupler and/or an on-chip photodetector configured to monitor performance of the at least one first switch.

According to at least one embodiment of the present disclosure, the at least one light source may include a first light source of a first wavelength and a second light source of a second wavelength, and the LiDAR device may further include a first switch and a second switch configured to separate the light to provide to the pixel array, and a wavelength selection switch configured to switch at least one of the first wavelength or the second wavelength to the first switch, and switch at least one of the first wavelength or the second wavelength to the second switch.

According to at least one embodiment of the present disclosure, the at least one light source may include a plurality of light sources having different wavelengths, and the LiDAR device may include a plurality of FPA systems having different grating periods of the radiator.

According to at least one embodiment of the present disclosure, the heater may include at least one of an n-i-n heater, a p-i-p heater, a p-i-n heater, a pn junction heater, or a thermal resistance heater.

According to at least one embodiment of the present disclosure, an intrinsic in the n-i-n heater, the p-i-p heater, or the p-i-n heater may include the radiator.

According to at least an embodiment of the present disclosure, a LiDAR device for vehicle including an FPA system is capable of two-dimensional beam steering through a one-dimensional pixel array arrangement and continuous steering of the beam radiated by a radiator for a longitudinal angle (θ), and thus high resolution may be secured.

In addition, with respect to steering the beam for a transverse angle (φ), the LiDAR device may have many advantages in terms of resolution quality because the LiDAR device has a structure that may easily dispose a greater number of pixels by taking advantage of one-dimensional pixel array arrangement.

In addition, a LiDAR device for a vehicle including an FPA system according to an embodiment of the present disclosure may have advantages in terms of element integration, price, and design complexity because the LiDAR device is capable of two-dimensional beam steering with a short-wavelength light source.

The methods and apparatuses of the present disclosure have other features and advantages which should be apparent from, or are set forth in more detail in, the accompanying drawings, which are incorporated herein, and the following Detailed Description, which together serve to explain certain principles of the present disclosure.

### BRIEF DESCRIPTION OF THE DRAWINGS

FIG. 1 illustrates configurations of a light detection and ranging (LiDAR) device for a vehicle according to an embodiment of the present disclosure.

FIG. 2 is a drawing defining a direction of light radiated from a radiator in a pixel array of a LiDAR device for a vehicle applying an FPA system according to an embodiment of the present disclosure.

FIG. 3A, FIG. 3B, and FIG. 3C illustrate a heater for controlling a first direction radiation angle of a radiator according to an embodiment of the present disclosure.

FIG. 4A and FIG. 4B illustrate a LiDAR device for a vehicle capable of expanding a first direction beam steering range of a radiator according to another embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, the same reference numerals refer to the same or equivalent parts of the present disclosure throughout the several figures of the drawing.

### DETAILED DESCRIPTION

While example embodiments are described with reference to the accompanying drawings, it should be understood that various changes and modifications may be made in other embodiments of the present disclosure. Further, it should be understood that the present disclosure is not necessarily limited to the specific example embodiments thereof, and various changes, equivalences, and substitutions may be made without departing from the scope and spirit of the present disclosure.

In the example embodiments of the present disclosure, terms such as “module”, “unit”, “part”, and the like, can be used for nominal distinction between components, and should not necessarily be interpreted as assuming that they are physically and/or chemically separated or capable of being separated or divided.

Terms containing ordinal numbers, such as “first”, “second”, and the like, may be used to describe various components, but such components are not necessarily limited by such terms. Such terms may be used only in a nominal sense to differentiate one component from another component, and their mutual sequential meaning should be understood through the context of the corresponding description.

The term “and/or” can be used to include all instances of any combination of multiple items being the subject. For example, “A and/or B” includes all three cases: “A”, “B”, and “A and B”.

When a component is used to be “coupled” or “connected” to another component, it should be understood that the component may be either connected directly to another component, or connected indirectly via another medium and/or intervening component(s). In addition, when a component, processor, device, element, apparatus, or the like of the present disclosure is described as having a purpose or performing an operation, function, or the like, the component, processor, device, element, apparatus, or the like should be considered herein as being “configured to” meet that purpose or to perform that operation or function.

Terms in the present application can be used to describe an example embodiment and are not intended to necessarily restrict and/or limit the present disclosure. Singular forms are intended to include plural forms unless the context clearly indicates otherwise. According to an embodiment of the present disclosure, terms such as “comprise” or “consist of” are used to designate presence of characteristics, numbers, steps, operations, elements, components, or a combination thereof, and do not foreclose the presence or possibility of addition of one or more other characteristics, numbers, steps, operations, elements, components, or a combination thereof.

Unless otherwise defined, terms used in the present disclosure, including technical or scientific terms, can have a same meaning as generally understood by an ordinary person skilled in the technical field to which the present disclosure pertains. Terms defined in commonly used dictionaries can be interpreted as having a meaning consistent with the meaning in the context of the related technology, and unless clearly defined in this application, should not be interpreted in an ideal or excessively formal sense.

In addition, the terms “unit”, “control unit”, “control device”, or “controller” can be widely used for names of devices that control the corresponding functions, and are not construed as being generic functional units. For example, devices using such terms may include a communication device that communicates with another controller or sensor to control the corresponding function, a computer-readable recording media that stores operating systems, logic commands, input/output information, and the like, and at least one or more processor that performs steps of determination, calculation, decision, and the like used to control the corresponding function.

A processor may include a semiconductor integrated circuit and/or electronic elements that perform at least one or more steps of comparison, determination, calculation, and decision to achieve a programmed function. For example, a processor may be one or the combination of a computer, a microprocessor, a CPU, an ASIC, and electronic circuits (circuitry, logic circuits).

A computer-readable recording medium (or referred to as memory or storage medium) can include all types of storage devices that store data that is read by a computer system. Examples of the computer-readable recording medium may include a memory of flash memory type, hard disk type, micro type, and card type (e.g. Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, or an optical disk type, or any combination thereof.

The recording medium may be electrically connected to the processor, and the processor may load and record data from the recording medium. The recording medium and the processor may be integrated or physically separated.

Hereinafter, an embodiment of the present disclosure is described in detail with reference to the attached drawings.

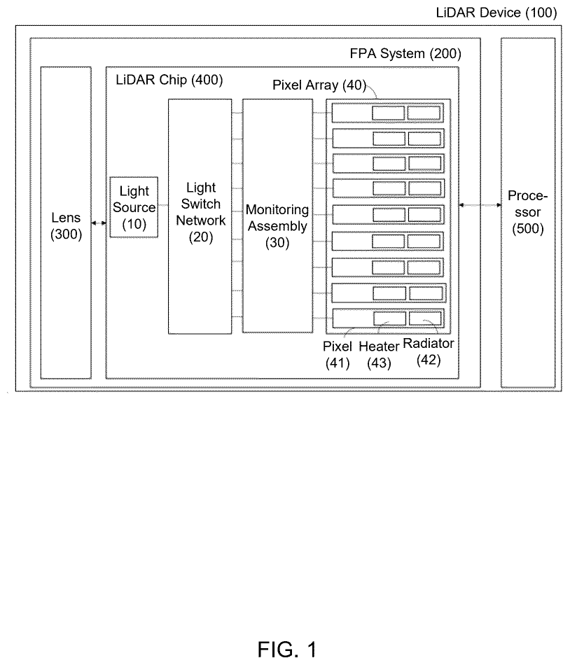

FIG. 1 illustrates configurations of a light detection and ranging (LiDAR) device for a vehicle according to an embodiment of the present disclosure.

FIG. 1 illustrates only the components needed to explain the embodiment, and in actual implementation, more components may be included.

Referring to FIG. 1, the LiDAR device 100 for a vehicle includes a focal plane array (FPA) system 200 including a LiDAR chip 400, a lens 300, and a processor 500. In addition, the LiDAR chip 400 includes a light source 10, a light switch network 20, a monitoring assembly 30, and a pixel array 40. In addition, the pixel array 40 includes a plurality of pixels 41, and each pixel 41 includes a radiator 42 and a heater 43.

The LiDAR device 100 provides information of one or more objects within a field of view (FOV) (e.g., a distance, a velocity, or an acceleration for the one or more objects). A frequency modulated continuous wave (FMCW) LiDAR device, which is an embodiment of the present disclosure, directly measures a distance and a velocity of an object by irradiating frequency modulated light to a target point. After reflected from the object, an optical signal returns to a scanner at a low intensity and is superimposed with a signal which is not emitted (generally referred to as a local oscillator signal). A resulting beat frequency may be detected by a detector, and a distance between the scanner and the object may be calculated. When Doppler shift is considered, a relative radial velocity between the scanner and the object may also be calculated. Although the present disclosure describes the FMCW LiDAR device as an example, the present disclosure is not limited thereto, i.e., other types of LiDAR devices, such as a time of flight (TOF) type LiDAR device may also be possible to implement an embodiment of the present disclosure.

The LiDAR chip 400 is a component of the FPA system 200 configured to scan an external environment. The LiDAR chip 400 may be a photonic integrated circuit based on silicon photonics. The LiDAR chip 400 includes the light source 10, the light switch network 20, the monitoring assembly 30, and the pixel array 40. As shown in FIG. 1, the light source 10 is integrated directly on the LiDAR chip 40. In some cases, the light source 10 may not be integrated on the LiDAR chip 400, and instead, light from an external light source may be coupled to the LiDAR chip 400. The light may also be amplified by a fiber amplifier or semiconductor amplifier chips.

The light source 10 irradiates light to be used in analysis of a position and a shape of an object of an external environment. For example, the light source 10 may include a light device such as a laser diode (LD), an edge emitting laser, a vertical-cavity surface emitting laser (VCSEL), a distributed feedback laser, a light emitting diode (LED), or a super luminescent diode (SLD), which generates and irradiates light of an infrared band wavelength. However, the present disclosure is not limited thereto. In addition, the light source 10 may generate and irradiate light of a plurality of different wavelength bands, and may generate and irradiate pulse light or continuous light. In the description of an embodiment of the present disclosure, a first light source 11 irradiates light of a wavelength band different from that of light irradiated from a second light source 12.

The light switch network 20 may switch guided light between output ports to activate the pixel 41 associated with a selected port. The light switch network 20 is configured to selectively provide the light to one or more of a plurality of output waveguides that are respectively coupled to the pixels 41 of the pixel array 40. In addition, the light switch network 20 may be configured in plurality (i.e., a plurality of light switch networks 20). In the description of an embodiment of the present disclosure, a first switch 11 refers to one of a plurality of light switch networks 20, and a second switch 12 to another.

The monitoring assembly 30 may be disposed anywhere on the chip 400 after the light switch network 20 or as an integrated portion of the light switch network 20. For example, as shown in FIG. 1, the monitoring assembly 30 may be disposed between the light switch network 20 and the pixel array 40. The monitoring assembly 30 includes a plurality of photodetectors. Each of the plurality of photodetectors may be configured to generate an output signal in response to a level of light detected from a corresponding output waveguide among the plurality of output waveguides. The light switch network 20 may be adjusted by adjusting driving strength of switch drivers for the light switch network 20 based on output signals of the monitoring assembly 30. The monitoring assembly 30 may include a directional coupler and an on-chip photodetector disposed in a waveguide of each channel, and a germanium photodetector, III-V, Si photon assisted tunneling photodetector (PAT-PD), or the like may be applied as a structure thereof. In addition, the monitoring assembly 30 may be configured in plurality (i.e., a plurality of monitoring assemblies 30), and in the description of an embodiment of the present disclosure, a first monitoring unit 31 refers to one of a plurality of monitoring assemblies 30, and a second monitoring unit 32 to another.

The pixel array 40 includes the pixels 41, and each of the pixels 41 may be configured to emit light provided by a corresponding output waveguide among the plurality of output waveguides. Each pixel 41 may include the radiator 42 and a waveguide for emitting and receiving a light signal, and other passive and active optical components for generating an RF signal, such as a coupler, hybrid, grating, the heater 43, and a photodetector. In addition, the pixel array 40 may be disposed in a focal plane of the lens 300.

The lens 300 may include one or more optical elements (for example, a positive lens, a freeform lens, a Fresnel lens, and the like) that map a physical position of each pixel 41 in a specific direction. In some embodiments, the lens 300 may be disposed to collimate transmitted signals emitted through a plurality of radiators 42. The lens 300 may be configured to project the transmitted signals emitted from the plurality of radiators 42 onto a portion corresponding to the FOV of the FPA system 200 and provide reflection of the transmitted signal to the radiators 42. The radiators 42 transmit and receive light at different angles, respectively. Therefore, discrete optical beam scanning is achieved by switching different radiators 42.

The processor 500 may control overall operations of the LiDAR device 100. In order to form a plurality of directions of light emitted from the radiators 42, the processor 500 may set a beam steering profile to be implemented by the FPA system 200 and controlling signals according to the beam steering profile. When the radiator 42 is provided with the heater 43, the processor 500 may transmit a command (i.e., a command or operation signal) for supplying power to control beam steering by applying heat to the heater 43. In addition, the processor 500 may control an operation of the light source 10 and the monitoring assembly 30. For example, the processor 500 may perform power supply control, on/off control, pulse wave (PW) or continuous wave (CW) generation control, and the like for the light source 10 (i.e., via control signals), and may apply a control signal for each of light detection elements of the monitoring assembly 30.

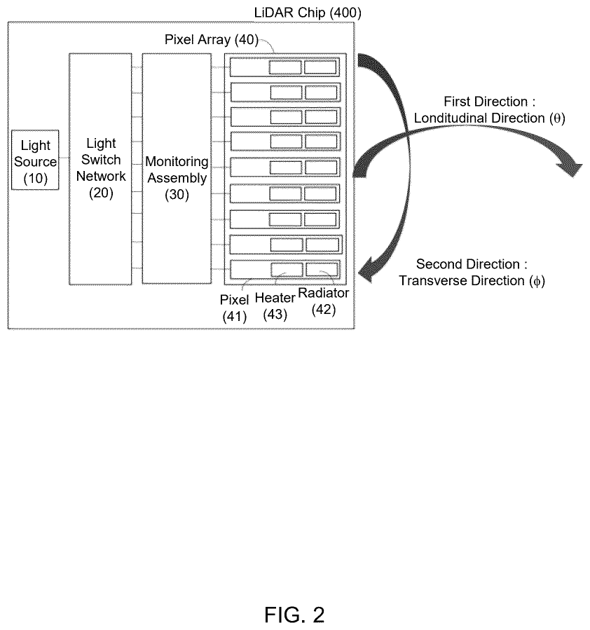

FIG. 2 illustrates a direction of light radiated from a radiator in a pixel array of a LiDAR device for a vehicle applying an FPA system according to an embodiment of the present disclosure.

Referring to FIG. 2, a LiDAR chip 400 includes a light source 10, the light switch network 20, a monitoring assembly 30, and a pixel array 40, each pixel 41 of the pixel array 40 including a heater 43 and a radiator 42.

The pixel array 40 may include at least one of a one-dimensional or two-dimensional arrangement of the pixels 41. In an embodiment of the present disclosure, the pixel array 40 is provided with light by an operation of the light switch network 20 having a structure of 1×N, and the pixel array may be formed as a one-dimensional array of 1×N (where N is an integer greater than or equal to 2) arrangement for a first direction and a second direction. The radiator 42 may include a structure in which a grating of a certain period is formed, and may radiate light to an external environment. The processor 500 may control the radiator 42 to steer a beam in a transverse direction (φ) and a longitudinal direction (θ), and the first direction may mean the longitudinal direction (θ), and the second direction may mean the transverse direction (φ).

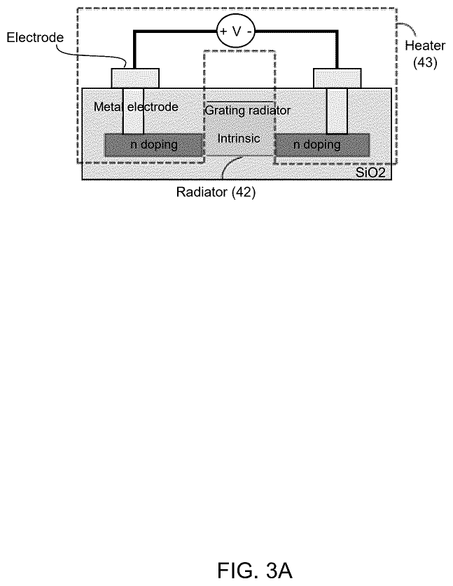

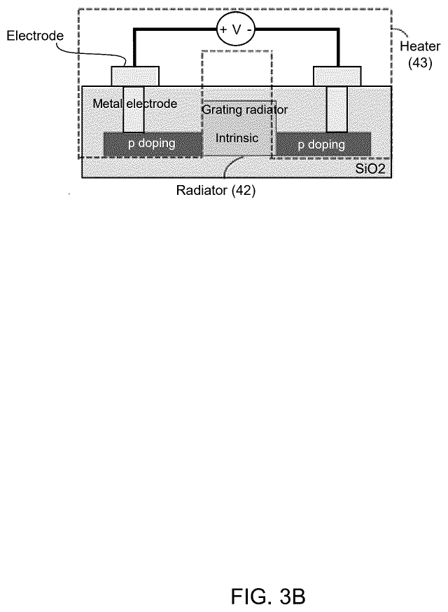

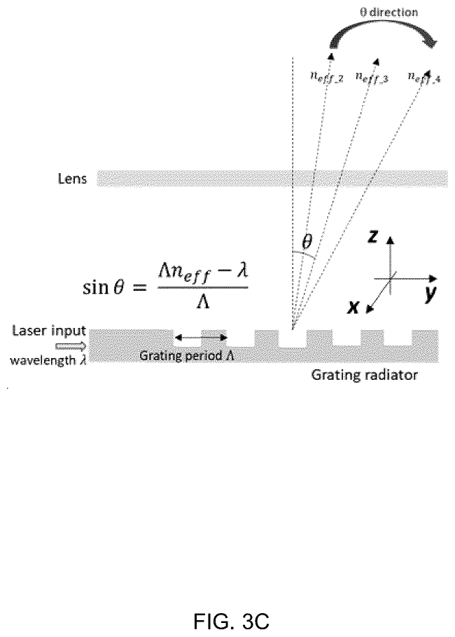

FIGS. 3A, 3B, and 3C illustrate a heater for controlling a first direction radiation angle θ of a radiator according to an embodiment of the present disclosure.

FIG. 3A illustrates an example of a heater 43 having an n-i-n structure, and FIG. 3B illustrates an example of a heater 43 having a p-i-p structure, where “n” refers to a layer of n-type semiconductor, “i” refers to a layer of intrinsic semiconductor material, and “p” refers to a p-type semiconductor layer. The heater 43 may be disposed at a portion that may directly heat the radiator 42. The heater 43 may include two electrodes, and the radiator 42 may be disposed between the two electrodes. The heater 43 may be manufactured by a complementary metal-oxide semiconductor (CMOS) process, and other than the n-i-n structure or p-i-p structure, a p-i-n structure or a pn junction structure may be applied to the heater 43. Also, a high-resistance metal heater or the like may be applied as the heater 43. Under a command of the processor 500, an operation signal may be provided to the at least one electrode of the heater 43. Under the command of the processor 500, when the operation signal is provided to the heater 43, heat may be generated by Joule-heating. The operation signal may include voltage, current, and power information. When a signal including the power information is provided to the heater 43, a temperature of the radiator 42 physically connected to the heater 43 may increase.

Referring to FIG. 3C, as the temperature of the radiator 42 increases, an effective refractive index of the radiator 42 may change. By changing the effective refractive index of the radiator 42, beam steering control for the first direction (longitudinal direction) angle θ may be possible. A light element that may actively control a radiation angle θ for the longitudinal direction, which is referred to as the first direction, by disposing the heater 43 in the radiator 42 portion, as described above, may be referred to as a tunable radiator.

The effective refractive index may be expressed as the following formula 1.

Formula 1

Δn_{eff}=(dn/dT)×ΔT

Where n_{eff} denotes an effective refractive index of a light waveguide including a grating, ΔT denotes a temperature change, and dn/dT denotes a refractive index change according to a temperature change.

A radiation angle change for the longitudinal direction may be expressed as the following formula 2.

Formula 2

θ=sin⁻¹(n_{eff}−λ/Λ)

Λ denotes a period of the grating, and λ denotes a wavelength of a period input light wave of the grating as shown in FIG. 3C.

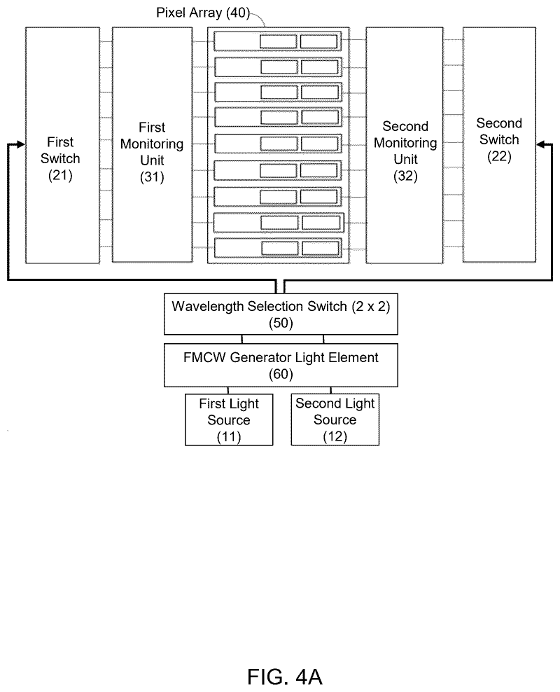

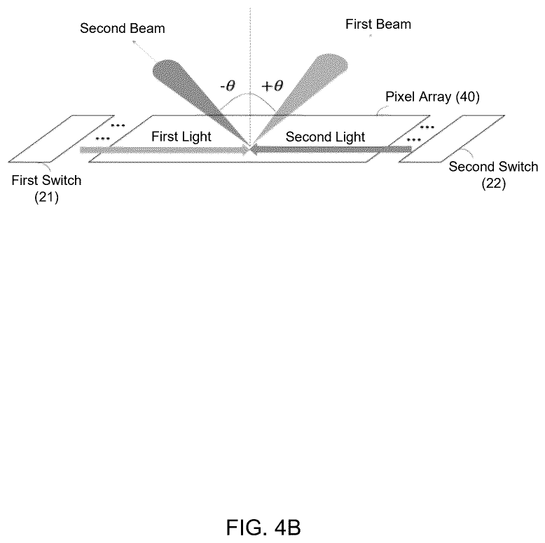

FIGS. 4A and 4B illustrate a LiDAR device for a vehicle capable of expanding a first direction beam steering range of a radiator according to another embodiment of the present disclosure.

Referring to FIG. 4A, the first direction beam steering range may be expanded by using an FPA system 200 in which light is supplied to both directions of the pixel array 40 of a LiDAR chip. The LiDAR device 100 comprises a plurality of light sources having different wavelengths (in an embodiment of the present disclosure, the first light source 11 and the second light source 12 are described as an example), an FMWC generator light element 60 capable of generating a laser chirp, and a wavelength selection switch 50 capable of selectively switching a wavelength. In the present disclosure, because the plurality of light sources are described as the first light source 11 and the second light source 12 as an example, the wavelength selection switch 50 may be a 2×2 switch. The wavelength selection switch 50 has a function of switching so that light may be sequentially supplied to the pixel array 40 in both directions.

Referring to FIG. 4B, the first light source 11 and the second light source 12 having different wavelengths provide respective light to the pixel array 40 in both directions through the first switch 21 and the second switch 22, and thus the beam steering range is expanded. Although not shown in FIG. 4B, it is understood that the radiator 42 configured to radiate input light as defined above is included in the pixel array 40. First light from the first light source 11 is radiated as a first beam steered through the radiator 42, and second light from the second light source 12 is radiated as a second beam steered through the radiator 42. In addition, the radiator 42 may further expand and control a range of the first direction radiation angle through a tunable radiator to which the heater 43 is applied. In addition, because the pixel array 40 is shared by two light sources having different wavelengths and expands the range of the first direction radiation angle, the chip size can be reduced compared to a conventional chip. In FIGS. 4A and 4B, an example of a case where light is provided in both directions to the single pixel array 40 is described, but a plurality of FPA systems 200 having different grating radiator periods may be included to expand the first direction beam steering range.

It is understood to those having ordinary skill in the art that the present disclosure may be embodied in other specific forms without departing from the spirit and essential characteristics of the present disclosure. Therefore, the above detailed description should not be construed as limiting the present disclosure in all aspects but should be considered as illustrative. The scope of the present disclosure should be determined by a reasonable interpretation of the appended claims, and all changes within the equivalent scope of the present disclosure are included in the scope of the present disclosure.

The method according to the embodiments described above may be produced as a software program or code to be executed on a computer, and the program may be stored in a computer-readable recording medium, and an example of the computer-readable recording medium includes that implemented in a form of a ROM, a RAM, a CD-ROM, a magnetic tape, a floppy disk, an optical data storage device, or the like.

The computer-readable recording medium may be distributed to multiple computer systems connected to each other via a communication network, and thus the computer-readable program or code may be stored and executed in a distributed manner. In addition, a functional program, a code, and code segments for implementing the method described above may be easily inferred by a programmer in the technical field to which the embodiment belongs.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teachings. The embodiments were chosen and described to explain certain principles of the present disclosure and their practical application, to enable others ordinarily skilled in the art to make and utilize various embodiments of the present disclosure, as well as various alternatives and modifications thereof. It is intended that the scope of the present disclosure be defined by the Claims appended hereto and their equivalents.

What is claimed is:

1. A light detection and ranging (LiDAR) device for a vehicle, the LiDAR device comprising:
at least one light source configured to generate light;
at least one focal plane array (FPA) system including a 1×N pixel array with 1 representing a first direction and N representing a second direction, each pixel of the pixel array including a radiator radiating the light;
a heater configured to supply heat to the radiator; and
a processor configured to control the pixel and the heater,
wherein the processor is further configured to transmit a command for supplying power to the heater to control a radiation angle for the first direction of the radiator.

2. The LiDAR device according to claim 1, wherein the command includes power information corresponding to the radiation angle for the first direction.

3. The LiDAR device according to claim 1, wherein the radiator includes a grating structure of a constant period.

4. The LiDAR device according to claim 1, wherein the radiation angle for the first direction is controlled by an effective refractive index of the radiator being changed according to a temperature.

5. The LiDAR device according to claim 1, further comprising:
at least one first switch configured to separate and provide the light to the pixel array.

6. The LiDAR device according to claim 5, further comprising:
a directional coupler, an on-chip photodetector, or a combination thereof configured to monitor performance of the at least one first switch.

7. The LiDAR device according to claim 1, wherein the at least one light source includes a first light source of a first wavelength and a second light source of a second wavelength, and
wherein the LiDAR device further includes a first switch and a second switch, the first switch and second switch configured to separate and provide the light to the pixel array, and a wavelength selection switch configured to switch at least one of the first wavelength or the second wavelength to the first switch, and switch at least one of the first wavelength or the second wavelength to the second switch.

8. The LiDAR device according to claim 1, wherein the at least one light source includes a plurality of light sources having different wavelengths, and
wherein the at least one FPA system includes a plurality of FPA systems having different grating periods of the radiator.

9. The LiDAR device according to claim 1, wherein the heater includes at least one of an n-i-n heater, a p-i-p heater, a p-i-n heater, a pn junction heater, or a thermal resistance heater.

10. The LiDAR device according to claim 9, wherein an intrinsic in the n-i-n heater, the p-i-p heater, or the p-i-n heater includes the radiator.

11. A vehicle including a light detection and ranging (LiDAR) device, wherein the LiDAR device comprises:
at least one light source configured to generate light;
at least one focal plane array (FPA) system including a 1×N pixel array with 1 representing a first direction and N representing a second direction, wherein each pixel of the pixel array includes a radiator radiating the light;
a heater configured to supply heat to the radiator; and
a processor configured to control the pixel and the heater, and
wherein the processor is further configured to transmit a command for supplying power to the heater to control a radiation angle for the first direction of the radiator.

12. The vehicle according to claim 11, wherein the command includes power information corresponding to the radiation angle for the first direction.

13. The vehicle according to claim 11, wherein the radiator includes a grating structure of a constant period.

14. The vehicle according to claim 11, wherein the radiation angle for the first direction is controlled by an effective refractive index of the radiator being changed according to a temperature.

15. The vehicle according to claim 11, wherein the LiDAR device further comprises:
at least one first switch configured to separate and provide the light to the pixel array.

16. The vehicle according to claim 15, wherein the LiDAR device further comprises:
a directional coupler, an on-chip photodetector, or a combination thereof configured to monitor performance of the at least one first switch.

17. The vehicle according to claim 11, wherein the at least one light source includes a first light source of a first wavelength and a second light source of a second wavelength, and
wherein the LiDAR device further includes a first switch and a second switch configured to separate and provide the light to the pixel array, and a wavelength selection switch configured to switch at least one of the first wavelength or the second wavelength to the first switch, and switch at least one of the first wavelength or the second wavelength to the second switch.

18. The vehicle according to claim 11, wherein the at least one light source includes a plurality of light sources having different wavelengths, and
wherein the at least one FPA system includes a plurality of FPA systems having different grating periods of the radiator.

19. The vehicle according to claim 11, wherein the heater includes at least one of an n-i-n heater, a p-i-p heater, a p-i-n heater, a pn junction heater, or a thermal resistance heater.

20. The vehicle according to claim 19, wherein an intrinsic in the n-i-n heater, the p-i-p heater, or the p-i-n heater includes the radiator.
